(19) United States
(12) Patent Application Publication
(10) Pub. No.: US 2008/0083337 A1
(43) Pub. Date: Apr. 10, 2008

(54) Air Cleaner Using Dust Collecting Filter

(76) Inventors: Kazuhiro Yamanaka, Osaka (JP); Hideyuki Karita, Nara (JP)

Correspondence Address: BIRCH STEWART KOLASCH & BIRCH, PO BOX 747, FALLS CHURCH, VA, 22040-0747, US

(21) Appl. No.: 11/631,307

(22) PCT Filed: Jul. 14, 2005
(86) PCT No.: PCT/JP05/13067

§ 371 Date: Jan. 3, 2007

(30) Foreign Application Priority Data
Aug. 2, 2004 (JP) 2004-226046

(51) Int. Cl. B01D 51/10

(52) U.S. Cl. 96/222; 96/226

(57) ABSTRACT

There are provided: an air blower 25 that introduces indoor air from an air inlet 13 and delivers the air through air outlets 29 and 30; and a dust collecting filter 55 that collects dust contained in air. The dust collecting filter 55 carries a porous microcapsule 37 impregnated with an aromatic agent, and is formed of an HEPA filter having a filtering material 55a impregnated with an antiviral agent. On the surface of the dust collecting filter 55, there is provided a breathable antibacterial sheet 37 impregnated with an antiallergenic agent.

### TECHNICAL FIELD

The present invention relates to a dust collecting filter for filtering air and an air cleaner using same, and more particularly to a dust collecting filter having a finctional substance, such as an aromatic agent, and an air cleaner using same.

### BACKGROUND ART

Japanese Patent Application Laid-open No. 2002-102327 (P. 4 to P. 10, FIG. 8) discloses a conventional air cleaner. This air cleaner has an air inlet and an air outlet on the front and back surfaces, respectively, of a housing thereof. In the housing, there is arranged an air blower, and, between the air blower and the air inlet, there is arranged a dust collecting filter for collecting dust. When the air blower is driven, dust contained in indoor air that has been introduced from the front into the housing through the air inlet is removed by the filter, and then the resulting air is delivered through the air outlet. This permits dust removal and thereby circulation of the cleaned air in the room.

Japanese Patent Application Laid-open No. H11-226326 (P. 3 to P. 6, FIG. 1) and Japanese Patent Application Laid-open No. H1-299557 (P. 5 to P. 7, FIG. 1) disclose air cleaners each having an antibacterial agent, an aromatic agent, or the like to provide comfortable living space. These air cleaners each include a microcapsule having an antibacterial agent or an aromatic agent encapsulated therein and carried by a dust collecting filter or a ribbon. Taking up the dust collecting filter or the ribbon at a predetermined period destroys the microcapsule, thereby causing a chemical substance, such as an antibacterial component or an aromatic component, to be released. This permits antibacterial effect or aromatic effect to be kept for a longer period than when the antibacterial agent or the aromatic agent is carried directly by the dust collecting filter.

### DISCLOSURE OF THE INVENTION

### Problems to Be Solved by the Invention

However, the aforementioned conventional air cleaner having an antibacterial agent or an aromatic agent requires a means for destroying a micro capsule, which results in a larger-size air cleaner, thus suffering from growth in its size and also an increase in its cost.

It is an object of the present invention to provide a dust collecting filter capable of releasing a chemical substance for a long period at low cost, and an air cleaner using same.

### Means for Solving the Problem

To achieve the object described above, according to one aspect of the invention, in a dust collecting filter having a filtering material for collecting dust, there is carried a porous microcapsule which is impregnated with a functional substance that performs a desired function by releasing a chemical substance into air. With this configuration, the passage of the air through the dust collecting filter causes dust contained in the air to be collected, and also causes the functional substance impregnated into the porous microcapsule to gradually release the chemical substance.

The functional substance is formed of an aromatic agent, a deodorant, an antiviral agent, or an antiallergenic agent. The chemical substance released from the aromatic agent or the deodorant flows together with the air, thereby providing aromatic or deodorant effect. The chemical substance released from the antibacterial agent accumulates on the surface of the dust collecting filter to thereby prevent bacteria propagation. The chemical substance released form the antiviral agent or the antiallergenic agent inactivates viruses or allergens contained in the air passing through the dust collecting filter.

In the dust collecting filter configured as described above, the functional substance is formed of an aromatic agent, and the filtering material is impregnated with an antiviral agent. With this configuration, viruses contained in the air passing through the dust collecting filter are inactivated by the antiviral agent impregnated into the filtering material formed of an unwoven fabric, paper, or the like. Moreover, the air contains aromatic components that are released from the aromatic agent impregnated into the microcapsule.

In the dust collecting filter configured as described above, the microcapsule is formed of a porous urethane resin.

In the dust collecting configured as described above, the microcapsule is dispersed in a solvent containing a binder dissolved therein, and then the filtering material is immersed in the solvent to thereby carry the microcapsule. With this configuration, the microcapsule impregnated with the functional substance is dispersed in the solvent containing an acrylate resin or the like therein, and then the filtering material is immersed in the solvent. As a result, the microcapsule is carried by the filtering material, with the resin serving as a binder.

According to another aspect of the invention, an air cleaner includes: the dust collecting filter configured as described above; and an air blower that introduces air from a room, makes the air pass through the dust collecting filter, and then delivers the air. With this configuration, when the air blower is driven, the indoor air is introduced and made pass through the dust collecting filter, whereby dust contained in the air is collected. Moreover, the chemical substance is gradually released from the functional substance impregnated into the porous microcapsule. The chemical substance flows together with the air to thereby perform its function. The chemical substance also accumulates on the surface of the dust collecting filter to thereby perform its function.

In the air cleaner configured as described above, the functional substance is formed of an aromatic agent, and wherein the dust collecting filter is formed of an HEPA filter having the filtering material impregnated with an antiviral agent.

In the air cleaner configured as described above, a breathable sheet impregnated with an antiallergenic agent is so provided as to face the dust collecting filter. With this configuration, allergens contained in the air passing through the sheet are inactivated by the antiallergenic agent.

### Advantages of the Invention

With a dust collecting filter of the present invention, a porous microcapsule is carried which is impregnated with a functional substance formed of an aromatic agent, a deodorant, an antiviral agent, an antiallergenic agent, or the like. Thus, a chemical substance can be gradually released, and thus this function can be maintained for a long period of time. Moreover, a device to be equipped with the dust collecting filter can be provided at low cost since it does not require a means for destroying a microcapsule.

With the present invention, the functional substance is formed of an aromatic agent, and the filtering material is impregnated with an antiviral agent. Thus, a dust collecting filter having a plurality of functions can be provided at low cost.

With the present invention, the microcapsule is formed of a porous urethane resin. Thus, a dust collecting filter that gradually releases a chemical substance can be achieved easily.

With the present invention, the filtering material is immersed in a solvent in which a binder is dissolved and also the microcapsule is dispersed to thereby carry the microcapsule. Thus, a dust collecting filter in which a microcapsule is carried can be provided easily.

With an air cleaner of the present invention, the porous microcapsule is carried which is impregnated with the functional substance formed of the aromatic agent, the deodorant, the antiviral agent, the antiallergenic agent, or the like. Thus, the chemical substance can be gradually released, and thus this function can be maintained for a long period of time. Moreover, any means for destroying a microcapsule is required, thus permitting providing at low cost an air cleaner capable of maintaining its effect for a long period.

With the present invention, the functional substance is formed of an aromatic agent, and the dust collecting filter is formed of an HEPA filter having the filtering material impregnated with the antiviral agent. Thus, an air cleaner that offers aromatic effect and virus inactivation effect can be provided at low cost.

With the present invention, a breathable sheet impregnated with an antiallergenic agent is so provided as to face the dust collecting filter. Thus, an air cleaner that offers allergen inactivation effect can be provided.

### BRIEF DESCRIPTION OF DRAWINGS

FIG. 1 is a perspective view illustrating an air cleaner according to an embodiment of the present invention.

FIG. 2 is a side sectional view illustrating the air cleaner according to the embodiment of the invention.

FIG. 3 is an exploded perspective view illustrating an air cleaning filter unit of the air cleaner according to the embodiment of the invention.

FIG. 4 is a perspective view illustrating a prefilter of the air cleaner according to the embodiment of the invention.

FIG. 5 is a perspective view illustrating a deodorizing filter of the air cleaner according to the embodiment of the invention.

FIG. 6 is a side view illustrating the deodorizing filter of the air cleaner according to the embodiment of the invention.

FIG. 7 is a side sectional view illustrating the deodorizing filter of the air cleaner according to the embodiment of the invention.

FIG. 8 is a perspective view illustrating a dust collecting filter of the air cleaner according to the embodiment of the invention.

FIG. 9 is an exploded perspective view illustrating the dust collecting filter of the air cleaner according to the embodiment of the invention.

FIG. 10 shows how a microcapsule is carried in the dust collecting filter of the air cleaner according to the embodiment of the invention.

FIG. 11 shows how the microcapsule is carried in the dust collecting filter of the air cleaner according to the embodiment of the invention.

FIG. 12 is a perspective view illustrating a filter holding frame of the air cleaner according to the embodiment of the invention.

FIG. 13 is a perspective view illustrating a frame body of the air cleaning filter unit of the air cleaner according to the embodiment of the invention.

FIG. 14 is a perspective view illustrating how the frame body is joined with the prefilter in the air cleaning filter unit of the air cleaner according to the embodiment of the inntion.

### LIST OF REFERENCE SYMBOLS

1 Air cleaner
10 Main body
12 Front panel
13 Air inlet
14 Side air inlet
15 Operation panel
20 Air cleaning filter unit
21 Humidification part
22 Humidifying filter
23 Tray
25 Air blower
26 Ion generator
27 Vent opening
28 Vent panel
29, 30 Air outlets
31 Vent passage
32 Space
36 Sheet
37 Microcapsule
38 Binder
52 Prefilter
53 Prefilter holding frame
54 Deodorizing filter
55 Dust collecting filter
55a Filtering material

### BEST MODE FOR CARRYING OUT THE INVENTION

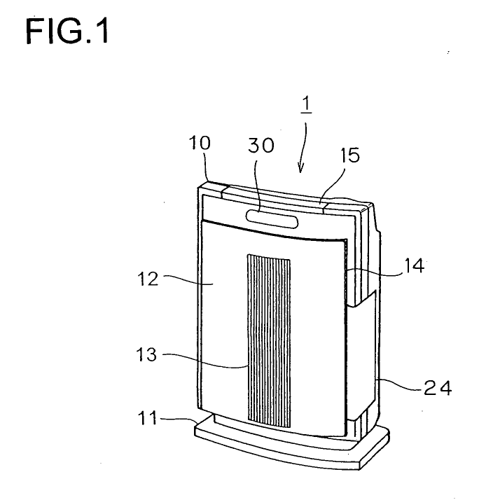

The embodiment of the present invention will be described below with reference to the accompanying drawings. FIG. 1 is a perspective view illustrating an air cleaner according to the embodiment. The air cleaner 1 has a main body 10 that is vertically arranged and supported by a base 11. The main body 10 has the front surface thereof covered by a front panel 12, in which an air inlet 13 is formed for introducing indoor air. A side air inlet 14 is formed by a space between the rim of the front panel 12 and the main body 10. On the top of the main body 10, there is arranged an operation panel 15 for operation performed by the user.

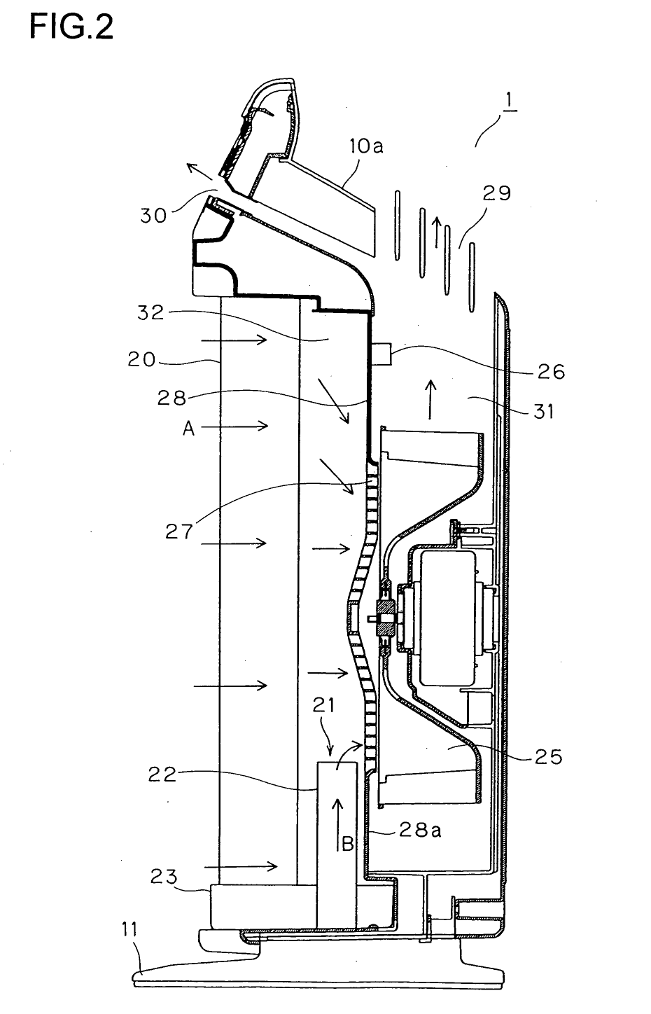

FIG. 2 is a side sectional view illustrating the air cleaner with the front panel 12 removed. Inside the main body 10, there is arranged an air blower that suctions air in the axial direction and exhausts air in the circumferential direction. The air blower 25 has the suction side thereof so disposed as to face the air inlet 13, and has the front surface thereof covered by a vent panel 28 having a vent opening 27. With this vent panel 28, there is formed in the rear portion of the main body 10 a vent passage 31 extending vertically. The vent passage 31 is provided with an air outlet 29 that opens upward and an outlet 30 that is curved obliquely upward and opens forward, thus permitting air in the air blower 25 to be led to the air outlets 29 and 30.

Between the air blower 25 and the air outlet 29, there is arranged an ion generator 26. The ion generator 26 has an electrode (not shown) that generates ions by high-voltage application. This electrode is so disposed as to face the vent passage 31. The arrangement of the ion generator 26 between the air outlet 29 and the air blower 25 can prevent ion loss caused by collision between ions and the air blower 25. The electrode that generates ions may be arranged in the vent passage 31, and the power source part and the like of the ion generator 26 may be arranged at different position.

Applied to the electrode of the ion generator 26 is a voltage of an alternating waveform or an impulse waveform. The application of a positive voltage to the electrode generates positive ions mainly containing H⁺ (H₂O)ₙ, whereas the application of a negative voltage to the electrode generates negative ions mainly containing O₂⁻(H₂O)ₘ, where n and m are arbitrary integer numbers. The H⁺ (H₂O)ₙ and O₂⁻(H₂O)ₘ aggregate on surfaces of floating fungus and odorous components contained in the air, and then surround them.

As shown in formulae (1) to (3), where n′ and m′ are arbitrary integer numbers, active species, [—OH] (hydroxyl radical) and H₂O₂ (hydrogen peroxide), are generated and aggregated on surfaces of microorganisms or the like by collision to thereby destroy the floating fungus and the odorous components. Thus, positive ions and negative ions can be generated and then delivered through the air outlets 29 and 30, thereby permitting sterilizing the room and removing odors.

H⁺(H₂O)ₙ+O₂⁻(H₂O)ₘ→.OH+½O₂+(n+m)H₂O (1)

H⁺(H₂O)ₙ+H⁺(H₂O)ₙ+O₂₋(H₂O)ₘ+O₂₋(H₂O)ₘ→2.OH+O₂+(n+n′+m+m′)H₂O (2)

H⁺(H₂O)ₙ+H⁺(H₂O)ₙ+O₂₋(H₂O)ₘ+O₂₋(H₂O)ₘ→H₂O₂+O₂+(n+n′+m+m′)H₂O (3)

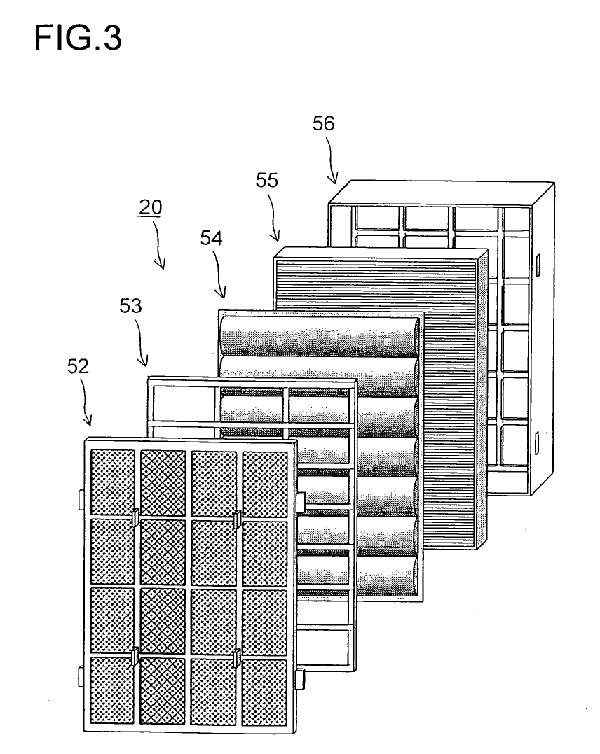

Between the front panel 12 and the vent panel 28, there is disposed an air cleaning filter unit 20 and a humidification part 21. The air cleaning filter unit 20 so disposed as to face the air inlet 13 (see FIG. 1) is designed to be incorporated into the air cleaner. FIG. 3 is an exploded perspective view of the air cleaning filter unit 20.

The air cleaning filter unit 20 has in a frame body 56 three types of filters including a prefilter 52, a deodorizing filter 54, and a dust collecting filter 55, which are arranged in this order from the air suction side. Between the prefilter 52 and the deodorizing filter 54, there is disposed a filter holding frame 53.

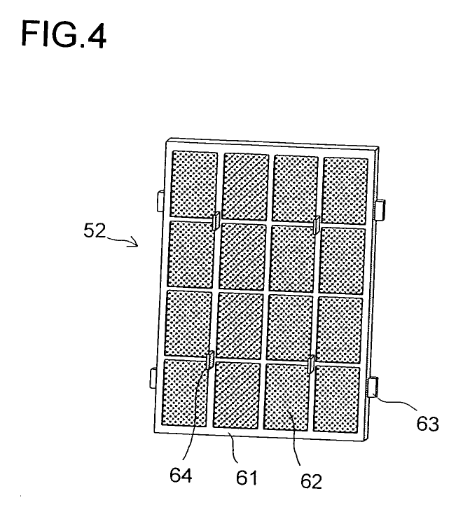

FIG. 4 is a perspective view illustrating the prefilter 52. The prefilter 52 is formed by welding together a rectangular frame 61 having a 4-column-by-4-row window formed of a synthetic resin, such as ABS, and a mesh 62 formed of polypropylene. The frame 61 has two projections 63 arranged on each side surface thereof and knobs 64 arranged on the front surface thereof in a protruding manner. The prefilter 52 permits collecting large-size dust contained in the suctioned air.

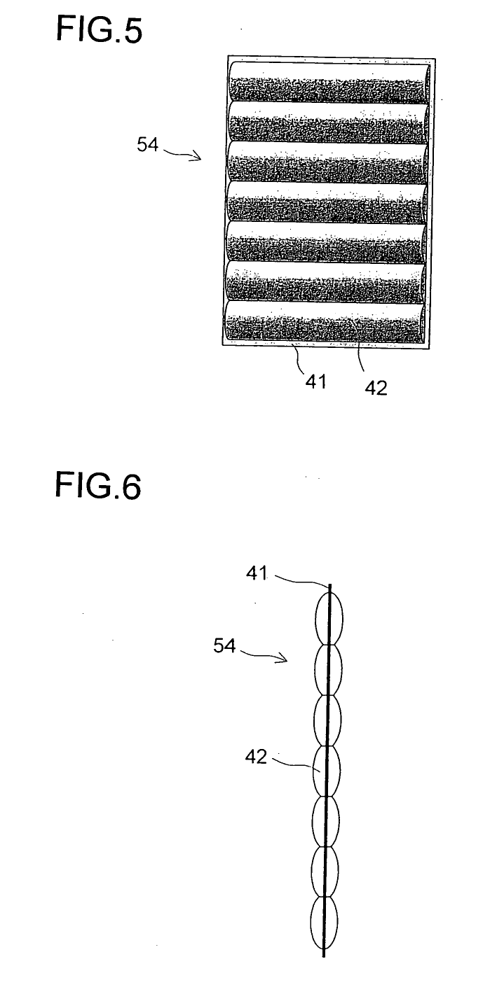

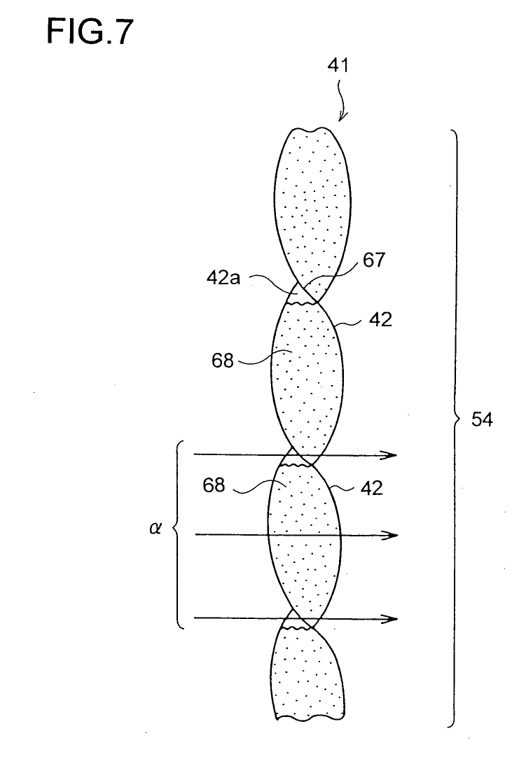

FIGS. 5 and 6 are a perspective view and a side view, respectively, illustrating the deodorizing filter 54. The deodorizing filter 54 has a rectangular bag body 41 formed of polypropylene fiber or polyester fiber. The bag body 41 is divided into housing chambers 42 of an equal size arranged continuously in a vertical direction. In each of the housing chambers 42, an absorbent 68 (see FIG. 7), such as active carbon, is so filled as to be evenly dispersed therein, which swells each housing chamber 42 to thereby form irregularities on the surface of the deodorizing filter 54. The number of housing chambers 42 is not limited; therefore, active carbon, such as coconut shell, coal pitch, polyacrylonitrile, and cellulose, may be used to form the absorbent 68.

FIG. 7 is a side sectional view of the deodorizing filter 54. Each housing chamber 42 is formed by seaming together the front surface side and the back surface side of the bag body 41 in such a manner that a seam 67 is slanted. When the deodorizing filter 54 is fitted, the absorbent 68 comes down under its own weight, thereby forming a space 42a at the top portion of each housing chamber 42. In this condition, the absorbent 68 is filled in the bottom portion of a housing chamber 42 immediately above each housing chamber 42 because the seam 67 is slanted.

Consequently, as shown by an arrow a, air entered into the deodorizing filter 54 passes therethrough while never failing to make contact with the absorbent 68 before released, thereby achieving improvement in deodorizing effect. Moreover, the bag bodies 41 only need to be arranged in a row, thereby achieving a slimmed-down deodorizing filter 54.

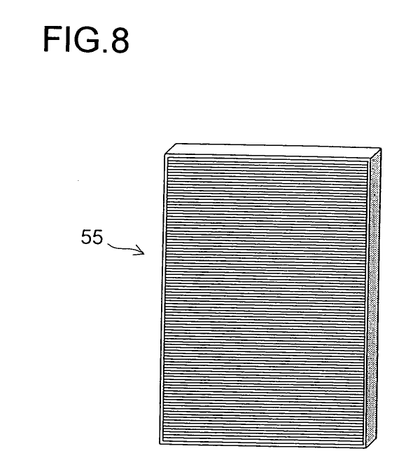

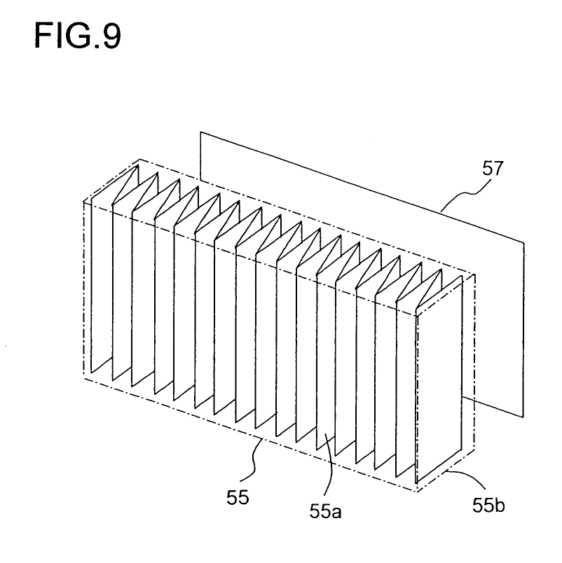

FIGS. 8 and 9 are a perspective view and an exploded perspective view of the dust collecting filter 55. The dust collecting filter 55 is formed of an HEPA filter formed by welding a frame member 55b to a filtering material 55a by hot melting such that the frame member 55b covers the filtering material 55a. The filtering material 55a is formed by laying an aggregate made of a polyester/vinylon unwoven fabric and a melt-blown non-woven fabric, one on the other, and then folding them. As the melt-blown nonwoven fabric, Tremicron (registered trademark) manufactured by Toray Industries, Inc., can be used which is given electret properties. This permits collecting fine dust while holding static electricity.

The polyester/vinylon unwoven fabric forming the filtering material 55a is impregnated with an antiviral agent formed of zinc pyridion, catechin, or the like. The antiviral agent can inactivate viruses contained in the air passing through the dust collecting filter 55.

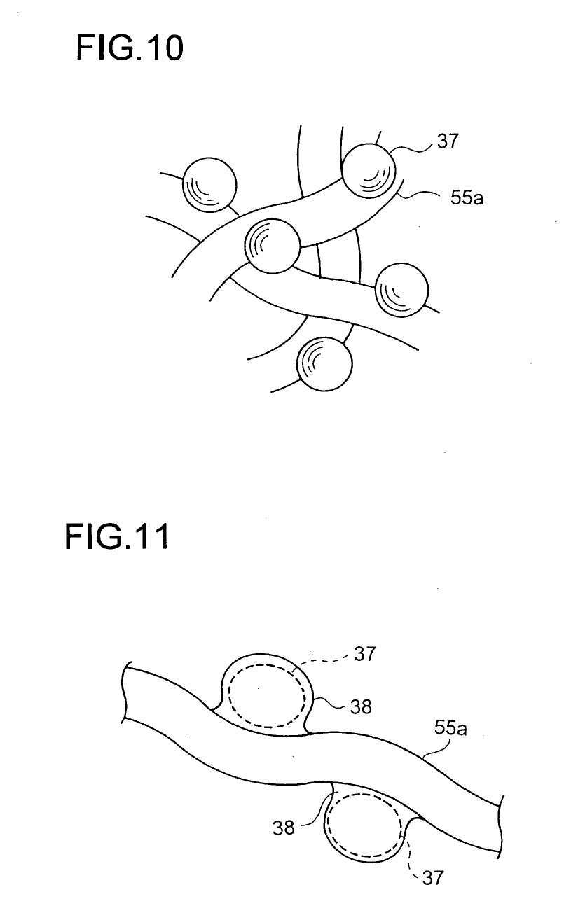

As shown in FIG. 10, the polyester/vinylon unwoven fabric carries a microcapsule 37 that is impregnated with an aromatic agent. The microcapsule is formed of a porous urethane resin and capable of holding the aromatic agent in a large number of fine pores thereof to gradually release a chemical substance of the aromatic agent.

The filtering material 55a made of the polyester/vinylon unwoven fabric is formed in the following manner. First, the microcapsule 37 impregnated with the aromatic agent is dispersed in a solvent containing an antiviral agent and an acrylate resin dissolved therein. Then, the polyester/vinylon unwoven fabric is immersed in the solvent. This permits the filtering material 55a to be impregnated with the antiviral agent, and also, as shown in FIG. 11, permits the acrylate resin to carry the microcapsule 37, serving as a breathable binder 38.

The thickness of the binder 38 can be changed in accordance with the concentration of acrylate resin contained in the solvent. Thus, the thickness of the binder can be increased to prolong the duration of aromatic effect provided by the aromatic agent, while the thickness of the binder 38 can be decreased to provide greater aromatic effect.

On the surface of the filtering material 55a, an antibacterial sheet 57 formed of an unwoven fabric subjected to hydroxyapatite processing is superposed by theremocompression bonding. The antibacterial sheet 57 is formed by immersing an unwoven fabric in a solvent containing an antiallergenic agent, such as hydroxyl apatite, dissolved therein so as to be impregnated with the antiallergenic agent. The antiallergenic agent can inactivate allergens contained in the air passing through the antibacterial sheet 57. As is the case with the antibacterial sheet 57, the frame member 55b is also impregnated with an antiallergenic agent, such as hydroxyapatite.

The dust collecting filter 55 configured as described above collects fine dust that is contained in the air introduced through the air inlet 13, and also inactivates viruses and allergens. In addition, the chemical substance is released from the aromatic agent to the air passing through the dust collecting filter 55.

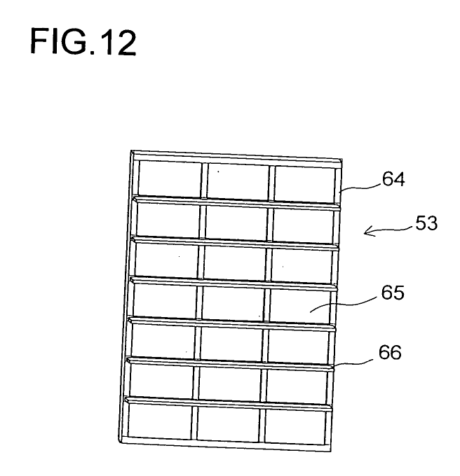

FIG. 12 is a perspective view of the filter holding frame 53 as viewed from the deodorizing filter 54 side. The filter holding frame 53 has a rectangular frame 64, within which square holes 65 are formed in a plurality of columns and a plurality of rows to permit airflow therethrough. The height of the square holes 65 is set in accordance with the irregularities of the surface of the deodorizing filter 54.

On the leeward side surface facing the deodorizing filter 54, there is provided a crosspiece-like projecting portion 66 between each vertically adjacent square holes 65. The projecting portion 66 has the same lateral width as that of the holding frame 53, and horizontally protrudes toward the deodorizing filter 54. This projecting portion 66 holds the deodorizing filter 54 and thereby prevents displacement of the deodorizing filter 54. The projecting portion 66 does not have to be provided in the crosspiece shape, but may be projected in a pin-like form.

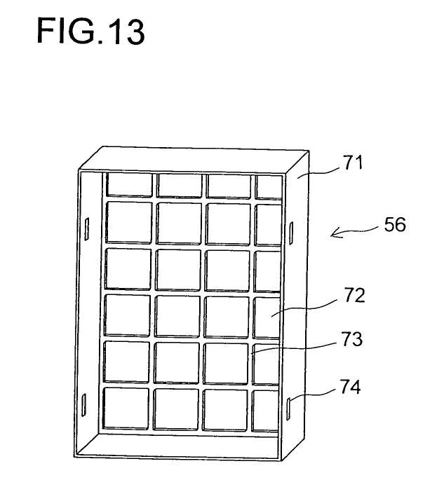

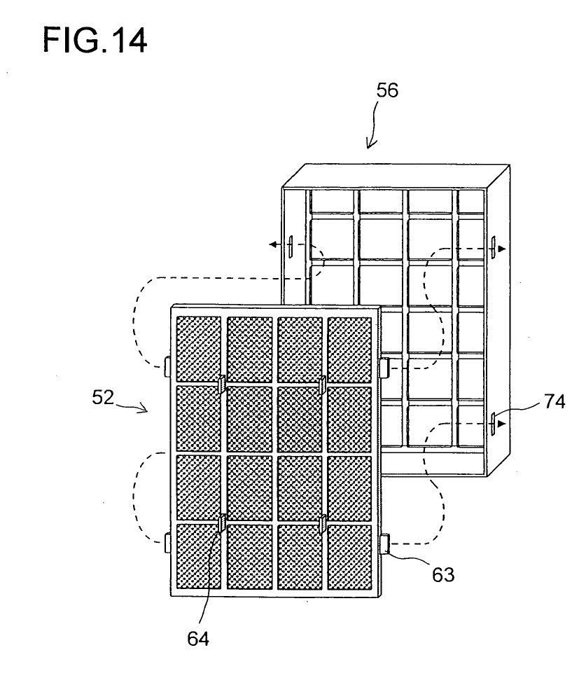

FIG. 13 is a perspective view of the frame body 56. The frame body 56 has a box member 71 whose windward side surface is open and whose leedward side surface is formed of a lattice frame 73 with square holes 72 that permit airflow therethrough. The lattice frame 73 is provided to prevent the dust collecting filter 55 from dropping out. The frame body 56 is configured to have such a thickness that permits storing therein the dust collecting filter 55, the deodorizing filter 54, the filter holding frame 53, and the prefilter 52. On both side surfaces of the box member 71, there are arranged two latch holes 74 each. As shown in FIG. 14, the projections 63 on the prefilter 52 fit with the latch holes 74, whereby the air cleaning filter unit 20 is integrally formed while preventing the deodorizing filter 54, etc., provided therein from dropping out therefrom.

In FIG. 2, a space 32 is formed with a predetermined width between the air cleaning filter unit 20 and the vent panel 28. Providing the space 32 permits air that has passed through the air cleaning filter unit 20 to smoothly flow into the vent opening 27 while reducing pressure loss and noise.

The humidification part 21 arranged in the lower portion of the space 32 has a humid ifying filter 22, a tray 23, and a water tank 24 (see FIG. 1). The water tank 24 stores water for humidification, and is vertically arranged on a side portion of the main body in a detachable manner. The tray 23 is connected to the water tank 24, and stores water supplied from the tank. The humidifying filter 22 is made of a water absorbent material that has water- absorbing property and is immersed in the tray 23. The humidifying filter 22 is formed in the shape of a folding screen that is bent in a zig-zag manner in the anteroposterior direction. Accordingly, the humidifying filter 22 sucks up water contained in the tray 23 and holds it.

In the air cleaner 1 described above, when the air blower 25 is driven, indoor air is introduced into the main body 10 through the air inlet 13. The air introduced through the air inlet 13 passes through the air cleaning filter unit 20, as shown by an arrow A (see FIG. 2), whereby the dust is collected and thus viruses and allergens are inactivated. The air that has passed through the air cleaning filter unit 20 thus includes aromatic components and flows into the vent passage 31 through the vent opening 27.

The lower air that has passed through the air cleaning filter unit 20 collides with the humidifying filter 22, and, since the back side of the humidifying filter 22 is shielded by a vent panel lower portion 28a, the air flows upward along the bent wall surfaces of the water- absorbent material as shown by an arrow B (see FIG. 2), during which moisture held by the humidifying filter 22 is introduced into the air, and then the humidified air flows into the vent passage 31 through the vent opening27. The air flowing through the vent passage 31 includes positive and negative ions generated by the ion generator 26, and is delivered into the room through the air outlets 29 and 30, thereby permitting sterilizing the room and removing odors.

By operating the operation panel 15 (see FIG. 1), switching can be made between a mode for delivering both positive and negative ions into the room and a mode for delivering only negative ions into the room. This permits the mode to be switched to deliver negative ions into the room to thereby achieve relaxation effect.

An ion delivered into the room has the periphery thereof surrounded by water molecules h. Therefore, the degree of collision between floating fungus, such as molds and viruses, in the air and the ion i increases. In addition, during the collision between the ion and dust contained in the air, the ion is protected by the water molecules, and thereby its loss is reduced. Thus, the floating fungus in the room can be removed quickly. Similarly, when only the negative ions are delivered into the room, the ions are surrounded by moisture, and thus its loss caused by collision with dust is reduced, thereby efficiently and quickly achieving relaxation effect.

According to the embodiment, the porous microcapsule 37 formed of a urethane resin impregnated with the aromatic agent is carried by the dust collecting filter 55. Thus, the substance is gradually released from the aromatic agent, thereby permitting aromatic effect to be maintained for a long period. Moreover, a means for destroying a microcapsule, such as is provided in the prior art, is no longer required, thus permitting cost reduction of the air cleaner 1. The microcapsule may be formed of a different material, for example, ceramic such as alumina, as long as it is porous.

Not only the aromatic agent, but also a functional substance that performs various functions by releasing a chemical substance may be impregnated into the microcapsule 37. For example, as a functional substance other than the aromatic agent, a deodorant, an antibacterial agent, an antiviral agent, an antiallergenic agent, or the like, may be impregnated. Impregnating the microcapsule 37 with the deodorant permits a chemical substance released form the deodorant to flow together with the air, thereby achieving deodorization of the room.

Impregnating the microcapsule 37 with the antibacterial agent causes the chemical substance released from the antibacterial agent to accumulate on the surface of the air cleaning filtering unit 20 when the air blower 25 is stopped, thereby preventing bacteria propagation. Impregnating the microcapsule 37 with an antiviral agent or an antiallergenic agent causes a chemical substance released from the antiviral agent or the antiallergenic agent to inactivate viruses or allergens contained in the air passing through the air cleaning filter unit 20.

### INDUSTRIAL APPLICABILITY

The present invention is applicable to a dust collecting filter for collecting dust, an air cleaner employing same, and an air conditioner having air cleaning capability.

1. An air cleaner comprising:
a filter unit made up of:
a prefilter for collecting dust;
a deodorizing filter for performing deodorization; and
a dust collecting filter for collecting smaller dust than dust collected by the prefilter, the dust collecting filter having a filtering material,
an ion generator for generating ions;
a humidification part for sendino moisture to air; and
an air blower for introducing air from a room and delivering the air,
wherein
the dust collecting filter has a frame member so provided as to cover the filtering material,
the filtering material is impregnated with an antiviral agent and the frame member is impregnated with an antiallergenic agent,
a porous microcapsule is held on a surface of the filtering material, the microcapsule being impregnated with a functional substance that performs a desired function by releasing a chemical substance into air.

2. The air cleaner according to claim 1,
wherein the microcapsule is dispersed in a solvent containing a binder dissolved therein, then the filtering material is immersed in the solvent to thereby carry the microcapsule, and a thickness of the binder is controlled by changing concentration of the binder.

3. The dust collecting filter according to claim 1,
wherein the functional substance is formed of an aromatic agent, and wherein the filtering material is impregnated with an antiviral agent.

4. The dust collecting filter according to claim 1,
wherein the microcapsule is formed of a porous urethane resin.

5. The dust collecting filter according to claim 1,
wherein the microcapsule is dispersed in a solvent containing a binder dissolved therein, and then the filtering material is immersed in the solvent to thereby carry the microcapsule.

6. An air cleaner comprising: the dust collecting filter according to claim 1;
and an air blower that introduces air from a room, makes the air pass through the dust collecting filter, and then delivers the air.

7. The air cleaner according to claim 6,
wherein the functional substance is formed of an aromatic agent, and wherein the dust collecting filter is formed of an HEPA filter having the filtering material impregnated with an antiviral agent.

8. The air cleaner according to claim 7,
wherein a breathable sheet impregnated with an antiallergenic agent is so provided as to face the dust collecting filter.

9. An air cleaner comprising: the dust collecting filter according to claim 2;
and an air blower that introduces air from a room, makes the air pass through the dust collecting filter, and then delivers the air.

10. An air cleaner comprising: the dust collecting filter according to claim 3;
and an air blower that introduces air from a room, makes the air pass through the dust collecting filter, and then delivers the air.

11. An air cleaner comprising: the dust collecting filter according to claim 4;
and an air blower that introduces air from a room, makes the air pass through the dust collecting filter, and then delivers the air.

12. An air cleaner comprising: collecting filter according to claim 5;
and an air blower that introduces air from a room, makes the air pass through the dust collecting filter, then delivers the air.
